(19) United States
(12) Patent Application Publication
(10) Pub. No.: US 2020/0133182 A1
(43) Pub. Date: Apr. 30, 2020

(54) DEFECT CLASSIFICATION IN AN IMAGE OR PRINTED OUTPUT

(71) Applicant: HP INDIGO B.V., Amstelveen (NL)

(72) Inventors: Oren Haik, Ness Ziona (IL); Oded Perry, Ness Ziona (IL); Eli Chen, Ness Ziona (IL)

(73) Assignee: HP INDIGO B.V., Amstelveen (NL)

(21) Appl. No.: 16/605,606

(22) PCT Filed: Apr. 20, 2017
(86) PCT No.: PCT/EP2017/059428

§ 371 Date: Oct. 16, 2019

(51) Int. Cl. G03G 15/00; H04N 1/00; H04N 1/60; H04N 1/40; G06K 9/62; G05B 13/02

(52) U.S. Cl. CPC G03G 15/5016; H04N 1/00042; H04N 1/6002; H04N 1/40068; B33Y 50/02; H04N 1/00092; G06K 9/627; G05B 13/027; H04N 1/00034

(57) ABSTRACT

A monitoring device includes circuitry to compare a printed output with a reference representing a target output and to determine potential defects in the printed output based on the comparison. The monitoring device further includes and circuitry to implement a convolutional neural network to classify each potential defect as a true defect or a false alarm.

### BACKGROUND

Various 2D and 3D printing technologies exist and are widely used day-to-day. However, despite continuing improvement in the technologies, defects (e.g. errors or imperfections) may be present in the printed output. The defects that may occur may depend on the particular printing technology.

### BRIEF DESCRIPTION OF THE DRAWINGS

Examples are further described hereinafter with reference to the accompanying drawings, in which:

FIG. 1 illustrates a monitoring device according to some examples.

FIG. 2 illustrates a printing device according to some examples.

FIG. 3 illustrates a method for determining whether or not there are any true defects in a printed output.

FIG. 4 illustrates an example of comparison circuitry according to some examples.

FIG. 5 shows a method according to some examples.

FIG. 6 shows a method according to some examples.

FIG. 7 illustrates a Siamese neural network according to some examples.

FIG. 8 illustrates a computer readable medium according to some examples.

### DETAILED DESCRIPTION

Artificial neural networks describe a computational model making use of a collection of simple units that are interconnected by links, the links enhancing or inhibiting an activation state of adjoining units. This arrangement approximately mimics the behavior of a biological brain, with each of the units approximating individual neurons. Herein the units may be referred to as neurons or artificial neurons. Artificial neural networks can be used in machine learning, which involves using a plurality of examples, each with a known, correct output for a given input, to train a neural network to produce an algorithm that can provide the correct output for new inputs. In some examples, artificial neural networks may be implements as functional units of program code implemented on general purpose processing circuitry.

In an example of an artificial neural network, an example group of neurons x₁, x₂ and x₃ may be linked or connected with another neuron y via links, and act as inputs to neuron y. Each link has an associated weight w₁, w₂ and w₃, and the value of neuron y depends on the respective values of neurons x₁, x₂ and x₃ and the related weights w₁, w₂ and w₃. For example, the value of neuron y may be determined according to y=F(w₁x₁+w₂x₂+w₃x₃), where F(x)=max(0,x).

Deep learning is concerned with neural networks that are based on hierarchical data processing. A layered arrangement of neurons is used with abstract concepts (“features”) being learned automatically from the lower layers at higher layers, as a side product of the learning process. Thus, in deep learning artificial neural networks a collection of neurons collectively learns complex functions (tasks) by using many layers. A deep learning neural network may include four or more layers, for example. The use of more layers may allow a higher accuracy representation. An artificial neural network may have an input layer, an output layer and a plurality of hidden layers between the input and output layers. Each layer has a plurality of neurons. Neurons in a particular hidden layer may be connected to neurons in a preceding layer and neurons in a subsequent layer by respective links or connections. A deep neural network may have two or more hidden layers. In some examples, one or more layers of the neural network may each have neurons arranged in three dimensions.

In some examples, neural networks are to be trained prior to use. The increasing availability of large-scale datasets, Graphical Processing Units (GPUs) and multicore/cluster systems may simplify training neural networks in some cases.

Convolutional Neural Networks (CNNs) are a category of artificial neural networks that have at least one convolutional layer. A CNN may include a hierarchal arrangement of layers of neurons, including one or more convolutional layers. A convolutional layer applies a convolutional kernel (or filter) to a receptive field of an input image (or previous layer).

The convolutional kernel describes an individual pattern, and is applied (convolved) across the width and height of an input volume. The neurons inside a convolutional layer may be connected to a small region (i.e. connected to neurons in a small region) of the previous layer. That is, a convolutional layer may have a small receptive field. This is in contrast to fully-connected neural networks. By enforcing a local connectivity pattern between neurons of adjacent layers, a CNN may exploit spatially local correlation. Where the input is a 2D image, the convolutional kernel may be applied to every part of the image. As an example, if an input image is 100×100×3 pixels (height×width×color), a filter of 5×5×3 pixels (corresponding to a small region of the input image) may be applied to each individual part/sub-section of the image. As convolutional layers are connected to small portions of the previous layer, the number of parameters used to describe the network may be reduced, permitting a reduction in the computing resources used by the neural network.

CNNs may include a combination of locally-connected layers and fully connected or completely connected layers.

CNNs may implement a hierarchical approach to learn how to detect given image features (thus providing feature detectors) that are increasingly abstract. For example, lower layers (where lower layers are closer to an input and higher layers are closer to an output) may detect lines and borders in an input image. Subsequent layers may detect basic shapes and curves. Higher layers may identify the shapes and curves as an ear and a nose. The highest layers may determine that the presence of ears and a nose implies the presence of a face, and that the input image includes a picture of a person.

In some examples, CNNs may be used for image classification tasks. In some examples, CNNs may be used to implement deep learning algorithms.

A CNN for image classification may have a plurality of convolution and rectifier layers, a plurality of pooling layers, and fully connected layers. The CNN is to recognize a non-zero integer number, K, classes of objects in the input images, and the final layer has K units that are normalized such that the sum over the K units of the final layer is 1. Each of the K units of the final layer corresponds with one of the K classes of objects, and the value of each unit in the final layer corresponds to the probability that the input image shows the corresponding class of objects.

Convolution acts as a template match and pooling corresponds with down-sampling. The rectifiers describe activation functions of the neurons, and may be implemented, for example, as Rectified Linear Units (ReLU). These add non-linearity, which aids in learning complex representations of the data. The fully connected layers have full connections to all activations in the previous layer. The convolution and pooling layers act as feature extractors, while the fully connected layers act as a classifier.

The structure of the CNN allows early layers (close to the input side) to identify small, simple features of the image, such as edges with various orientations or blobs of color. Subsequent layers identify combinations of features from the preceding layer, allowing for progressively more complicated features to be extracted.

The convolutional layers may have fewer connections to their respective preceding layer than the fully connected layers have to their respective preceding layer.

In an example method of training an image classification neural network, the network is first initialized by assigning initial values to the parameters (e.g. weights) that define the network. These may be initialized with random values. In some examples, transfer learning may be used to provide initial values for the parameters, as described below.

A training image is input into the network and processed by the network to provide an output, with the output being a probability for each of a defined set of classes. The error between the received output and a correct result (the desired output) is then determined. The weights describing the neural network are adjusted or updated to reduce or minimize the output error. This may be according to

$$w = {w}_{i} - η \frac{d L}{dw} ,$$

where w is the new weight, wᵢ is the initial weight for this iteration (i.e. the current value of the weight), η is a parameter that determines the learning rate and, L is a loss function. For example, the loss function may be the mean square error between the received out and the target (desired) output: E=Σ½(target−output)². If any more training images remain to be processed the next training image is selected and processed and the weights adjusted. This repeats until there are no remaining training images.

When the image classification network has been trained, it may be validated using new images (i.e. images different from the training images). The new images are input to the network and the output classification for each image is compared with the correct result for that image.

Training neural networks for tasks other than image classification may be performed in a similar manner.

In some examples, transfer learning may be used to simplify training a neural net for a particular task. In the example of image classification, a neural network may be trained on a particular set of training data to classify images into a first set of classes. The upper layers, which perform the classification, are specific to the first set of classes. In contrast, the lower layers act as a feature extractor, which is likely to have broad applicability to image classification tasks. Accordingly, if a new neural network is to be trained to classify images into a different set of classes, the lower levels of the original neural network may be used unchanged (i.e. keeping the weights fixed) and the training may be applied mainly or exclusively to the upper layers.

Where a defect occurs in a printed output (e.g. an object or image) of a printing device (e.g. a 2D printer or a 3D printer), it may be appropriate to re-print the defective object or image. In some cases, a failure to notice or detect a defect may lead to additional cost or inconvenience. For example, early detection may allow an adjustment or repair to prevent similar defects in subsequent printed outputs. In another example, early detection of a defect (e.g. prior to distribution of the printed output) may allow a timely replacement being provided. In further example, timely detection of a defect may allow the defect to be corrected before the printed output is put into use.

Manual detection of defects may be onerous, and in high speed processes it may not be possible to perform manual inspection as part of an in-line process, leading to a delay in the process or a delay in defect detection. Furthermore, manual detection of defects allows for defects to be overlooked, or for variation in standards for classification of a defect.

In some examples a printed output may be automatically compared with a target output to determine potential defects. The target output may be a digital representation of a desired output, such as a digital image representing an image to be printed on a medium or a digital description or representation of a 3-dimensional (3D) object to be printed. In some examples the target output may be derived from an input print job.

In some examples a neural network may be used to classify each of the potential defects (or a subset of the potential defects) as a true defect or a false alarm.

According to this arrangement, the processing by the neural network is not applied directly to the printed output, but to potential defects identified using the target output. This may improve efficiency by reducing the input data amount than the CNN is to process to distinguish between true defects and falsely detected defects because a subset of the total image area or volume be processed by the neural network. Inputting potential defects to the neural network allows the information that is available in the target output to be utilized in determining whether or not defects are present. This, in turn, reduces or removes the risk of the neural network incorrectly identifying a defect in a portion of the printed output that does not deviate from corresponding portion of the target output, for example.

Further, in some arrangements the amount of processing to be performed by the neural network may be reduced, since in some examples identified potential defects are to be processed by the neural network, rather than the whole printed output.

According to some examples, it may be possible to reduce or eliminate manual checking and intervention for defect detection.

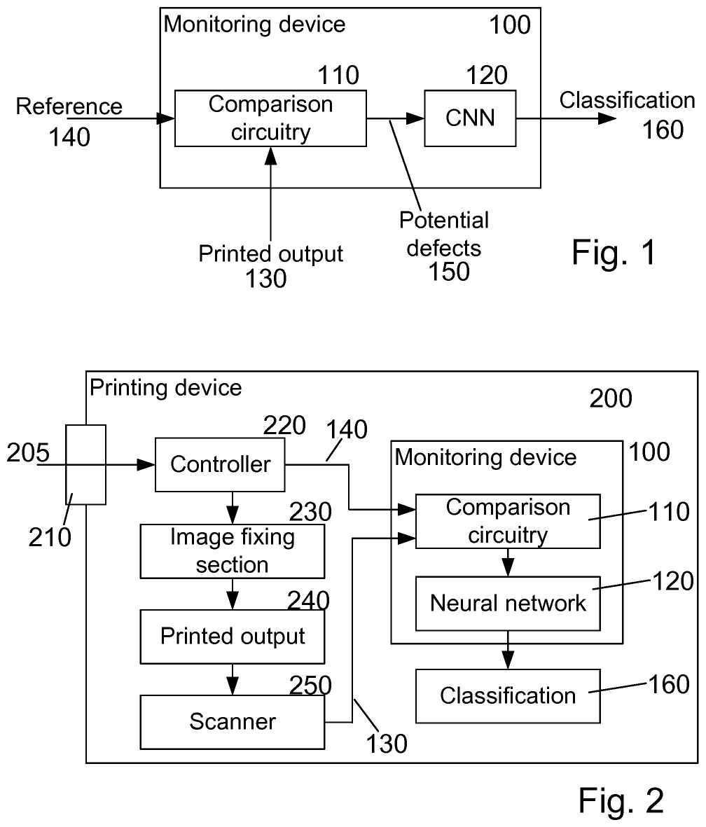

FIG. 1 illustrates a monitoring device 100 according to an example. The monitoring device includes comparison circuitry 110 and a convolutional neural network 120. The comparison circuitry 110 is arranged to compare a printed output 130 (or a second digital image representing the printed output) with a reference 140, the reference being a first digital image representing a target output. The comparison circuitry is arranged to determine potential defects 150 in the printed output based on the comparison. The CNN 120 is to classify each of the potential defects 150 as either a true defect or a false alarm, and may output a classification 160, appropriately.

The CNN may include an input layer (not shown) for receiving a description of each of the potential defects from the comparison circuitry. The CNN may also include an output layer for outputting the classification of the potential defects as either a true defect or a false alarm. A plurality of hidden layers may be provided between the input layer and the output layer.

In some examples, the CNN may classify each defect as one of a plurality of classes, with one or more of the classes corresponding with a false alarm and one or more classes corresponding with a true defect. Accordingly, the classes output by the CNN may deviate from strict correspondence with one true defect class and one false alarm class, while still classifying a potential defect as a true defect or a false alarm. For example, the CNN may classify a potential defect as one of a true defect or one of Moiré, dust, noise, illumination and color inconsistency, misalignment, where each of Moiré, dust, noise, illumination and color inconsistency, misalignment correspond with a false alarm determination. For example, Moiré, dust, noise, illumination and color inconsistency may describe differences between the first and second digital images that are due to errors in capturing the second digital image, rather than errors in the printed output. Misalignment may describe differences between the first and second digital images due to imperfect alignment between the first and second digital images when they are compared by comparison circuitry 110.

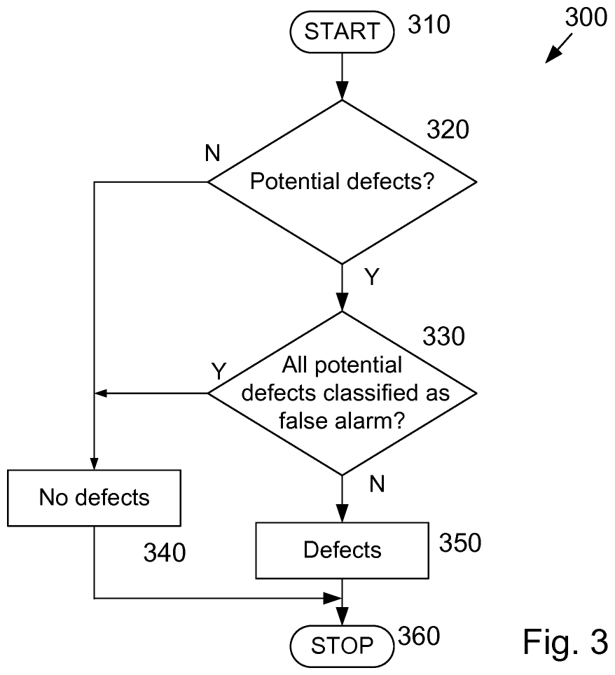

FIG. 2 illustrates a printing device 200 according to some examples. The arrangement of FIG. 2 is a printing device for applying a 2-dimensional (2D) image to a substrate. Accordingly, in some examples the reference is a digital image (a first digital image) describing an image to be printed on the substrate (a target output image). The printed output 240 may be a printed medium that is printed by the printing device 200.

Print instructions 205, such as a print job, are received at input 210. Print instructions 205 may include a digital description of an image to be printed on a substrate.

The printing device 200 may include one or more control elements, illustrated as controller 220, to control the various components of the printing device 200. The controller 220 may be implemented in software, hardware, firmware or a combination of these.

The controller controls an image fixing section 230 to print or otherwise fix the image to a substrate to generate printed output 240. The image fixing section 230 may be, for example, a digital press, offset press, inkjet printer, toner printer, etc.

The printed output 240 is scanned by scanner 250, and may subsequently be output from the printing device 200. In some examples, the handling of the printed output 240 may be dependent on whether or not any true defects are determined to be present. For example, the output may be paused until a user has intervened, or an output path of the printed output 240 may be changed, in response to a determination by the monitoring device 100 that a true defect is present.

The scanner 250 outputs a digital representation (a second digital image) 130 of the printed output 240 to the comparison circuitry 110 of monitoring device 100. In addition, controller 220 provides a reference, in the form of a digital representation of the image to be printed, based on print instructions 205. The comparison circuitry and neural network may then determine whether or not there are any true defects, as described in relation to FIG. 1.

In some examples, the scanner 250 is an in-line scanner. In some examples, the scanner 250 may also be used in other functionality of the printing device 200. For example, the scanner may be used in calibration of the printing device 200, such as color calibration, dot size calibration, color plane registration, etc.

In FIG. 2, the various components are illustrated as being part of the printing device 200. However, in some examples, some components may be provided separately from the printing device, in different functional processing units, for example.

In some examples the printing device 200 may be a press, such as a commercial press. In some examples, in order to maintain high throughput, the printed output may be moving at high speed (e.g. around 1280 mm/s) when the scanner scans the printed output to generate the second digital image. This can lead to a reduction in quality and/or accuracy of the second digital image relative to a scan performed when the printed output is static. A reduction in quality and/or accuracy of the second digital image may increase the difficulty of accurate defect detection.

In some examples, a low-quality scanner may be used. For example, where the scanner is provided to perform a function such as color calibration, dot size calibration, color plane registration, etc. the scanner may be selected to have sufficient quality for that function, while meeting other constraints, such as low cost. The use of a low-quality scanner may increase the difficulty of accurate defect detection.

In some applications, such as variable-data printing, each successive printed output may be different (have a different image printed on it). In such cases, the defect detection mechanism should be adaptable to accurately assess defects in the various outputs, without retraining and/or without user intervention during the determination (in some examples, a user may be alerted if a defect is detected).

In some arrangements, these issues may be present concurrently; a low-quality scanner may be used to capture the second digital image from a fast-moving printed output, with each successive printed output being different. According to some examples, the arrangement of FIG. 1 may provide reliable defect detection with a low error rate, even when two or more of these issues are present in combination.

FIG. 3 illustrates a method 300 for determining whether or not there are any true defects in a printed output. The method begins at 310, and at 320 it is determined whether or not any potential defects are found by the comparison circuitry between the printed output and the reference. If no differences are detected, it is determined that no defects are present at 340 and the method terminates at 360. If, at 320, it is determined that a potential defect is present, the method advances to 330, where it is determined whether all potential defects are classified by the neural network as a false alarm. If all potential defects are classified as false alarms, it is determined that no defects are present at 340 and the method terminates at 360. Conversely, if it is determined at 330 that one or more potential defects are classified as true defects, it is determined that defects are present in the printed output at 350 and the method terminates at 360. The determination that there are no true defects or that there are true defects may be output to, for example, control handling of the printed output, alert a user, etc.

In some examples, the classification may include a plurality of classes corresponding with the false alarm determination, with the plurality of classes corresponding with different types of false alarm. There may also be one or more classes corresponding to a determination that there is a true defect. For example, the classification may classify each potential defect as one of the following classes: Real Defect and one or more of Moiré, Dust, Noise, Illumination and Color Inconsistency, and Misalignment.

In some examples, the first digital image (the reference representing a target output), and the second digital image (representing the printed output) might not be suitable for direct comparison with each other. For example different image format or parameters may complicate a direct comparison.

In order to facilitate the comparison to be performed by the comparison circuitry, the comparison circuitry 110 (see FIG. 2) may modify one or both of the first and second digital images.

According to some examples, the first and second digital images may be described with respect to different color spaces, and in some examples the comparison circuitry may convert a color space of the first digital image to match the color space of the second digital image. For example, the first digital image may be in a CMYK color space and the second digital image may be in a RGB color space, and the comparison circuitry may convert the first digital image to a representation in the RGB color space. According to some examples, the comparison circuitry may convert the first digital image from the CMYK color space to a Lab color space and then to the RGB color space. Such a color space conversion via the Lab color space may be less complicated and may provide better results.

In other examples other color space conversions may be performed, as appropriate. In some examples the second digital image may be converted to match a color space of the first digital image. In some examples, both the first and second digital image may be converted from respective first and second color spaces to a third color space, different from the first and second color spaces.

In some examples, an image resolution of the first digital image may differ from an image resolution of the second digital image. In some examples the comparison circuitry modifies the resolution of one or both of the first and second digital images such that the resolutions match or become more similar. For example, the resolution of the first digital image may be adjusted to match the resolution of the second digital image

In some examples the registration (mapping for correspondence) between elements of the first and second digital image may be improved by performing a registration process. When comparing the images, a translation or rotation of one image with respect to the other may lead to inaccuracies in the comparison result, such as incorrect identification of potential defects. In some examples dedicated marks, such as print registration marks, may be provided in the reference and printed image to assist with registration. In other examples, registration may be performed based on user content of the image to be printed. Here, user content describes the image that the user intends to be printed, excluding marks or other indications or metadata associated with the printing process, such as print registration marks, color bars and trim marks, etc.

In some examples global template matching may be used to achieve a coarse alignment between the first and second digital images, and local template matching may be carried out to achieve finer alignment. In some examples the local alignment may be carried out by dividing each of the first digital image and the second digital image into a plurality of non-overlapping blocks (e.g. 15 blocks) and performing local template matching on individual blocks. A technique based on Adaptive Rood Pattern Search may be used for the local template matching. In some examples the registration process may modify the second digital image to improve registration with the first digital image (which may in this example be unchanged during the registration process). However, in other examples the first digital image may be modified to improve registration with the second digital image, or both the first and second digital images may be modified, such that the registration between the modified first digital image and modified second digital image are improved.

In some examples, one or both of the first and second digital images may be modified to reduce color inconsistencies between the first and second digital images. In some examples, color inconsistencies may be introduced during the scanning process, when capturing the second digital image. A color histogram match may be applied between the first and second digital images to reduce color inconsistencies between the digital images. In some examples, the second digital image is modified to reduce color inconsistencies relative to the first digital image. In some examples the first digital image, or both the first and second digital images may be modified to reduce color inconsistencies.

In some examples, potential defects may be identified by determining differences between the first and second digital images. In some examples, the differences may be determined by subtracting pixel values in one image from those in the other to generate a difference map. In other examples, a difference map may be generated using a structural similarity (SSIM) index. SSIM may be used to compare images in a manner that seeks to take into account, via an algorithm, factors relevant to human perception of the difference between images. For example, taking into account luminance masking and contrast masking. Luminance masking is a phenomenon whereby image distortions tend to be less visible in bright regions, while contrast masking is a phenomenon whereby distortions become less visible where there is significant activity or “texture” in the image.

In some examples, differences between the first and second digital images may be categorized as significant or not significant. Significant differences may be corresponded with potential defects and processed by the neural network to determine whether or not the significant difference is a true defect or a false alarm. In some examples, differences that are determined to be not significant may be ignored and not processed further.

In some examples, the categorizing of a difference as significant or not significant may depend on one or more of a size of the difference (e.g. an area measured in pixels), a brightness of pixel value(s) of the difference in the difference map, which may be a measure of a difference in color or brightness between the first and second digital images. According to some examples, faint, small (i.e. having a small area) or thin differences may be categorized as not significant.

In some examples the defect map may be evaluated on a patchwise basis, with the difference map being divided into patches and each patch being evaluated as including a significant difference or not.

Where SSIM is used to generate the difference map, an SSIM index associated with each difference (or with each patch) may be compared with a threshold to determine whether the difference (or differences within the patch) are to be categorized as significant or not significant.

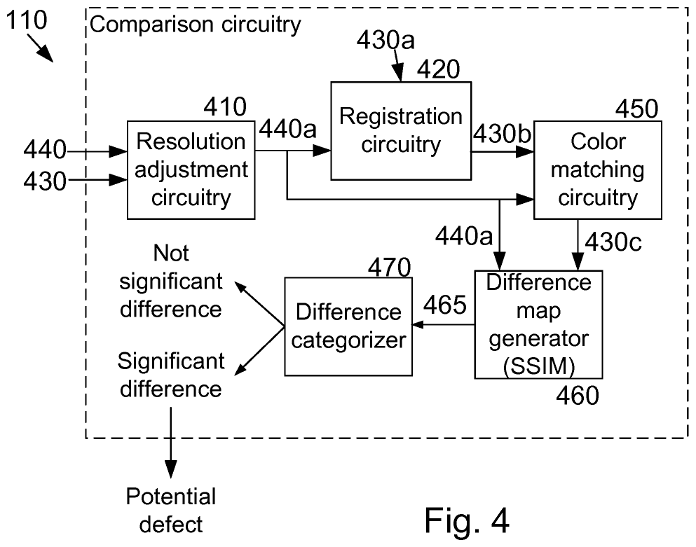

FIG. 4 illustrates an example of comparison circuitry 110 to process and compare first and second digital images. The comparison circuitry 110 of this example includes resolution adjustment circuitry 410, registration circuitry 420, color matching circuitry 450, a difference map generator 460 and a difference categorizer 470.

The resolution adjustment circuitry 410 may receive the first input 440 and second input 430. The first 440 and second 430 inputs may be digital images, such as the first digital image 140 and the second digital image 130, respectively. The resolution adjustment circuitry may be arranged to adjust the resolution of the first input 440 to match (be the same or be more similar to) the resolution of the second input 430. The resolution adjustment circuitry outputs a modified version 440a of the first input 440. Where the first input 440 is the first digital image 140 the output 440a may be referred to as the first digital image, the modified first digital image or the resolution-adjusted first digital image. In some examples the resolution adjustment circuitry 410 may receive the first input 440 and target resolution information. For example, where the first input 440 is the first digital image 140, the target resolution information may describe the resolution of the second digital image. In this case, the second input to the resolution adjustment circuitry may be the target resolution information, instead of the second digital image.

The registration circuitry 420 is arranged to receive a first input 440a and a second input 430a. The first input and the second input may be digital images. In the example of FIG. 4, the first input is the first digital image 440a, as output from the resolution adjustment circuitry. The second input 430a may be the second digital image 130.

Registration circuitry 420 may carry out registration between the digital image of the first input and the digital image of the second input to improve an alignment between features of the digital images. The registration circuitry may output a modified version 430b of the image of the second input 430a, adjusted to improve registration with the image of the first input.

Where the second input 430a is the second digital image, the output 430b may be referred to as the second digital image, the modified second digital image or the registration-adjusted second digital image.

Color matching circuitry 450 may be arranged to receive a first input 440a and a second input 430b, representing respective digital images, and adjust the image of the second input such that color inconsistencies between the adjusted image and the image of the first input are reduced relative to color inconsistencies between the unadjusted image of the second input 430b and the image of the first input 440a. The adjusted image 430c may be output from the color matching circuitry 450.

In the example of FIG. 4, the first input to the color matching circuitry is the first digital image 440a, as modified by the resolution adjustment circuitry 410, and the second input 430b is the second digital image as modified by the registration circuitry 420. The output 430c may be an adjusted version of the second digital image 430b as received from the registration circuitry 420. In this case, the output of the color matching circuitry 430c may be referred to as the second digital image, the modified second digital image or the color-adjusted second digital image.

Difference map generator 460 may receive first and second inputs and generate a difference map based on the first and second inputs. In the example of FIG. 4, the difference map is based on a SSIM index. In the arrangement of FIG. 4, the first input corresponds with the first digital data 440a, as modified by the resolution adjustment circuitry 410, and the second input corresponds with the second digital data 430c, as adjusted by the color matching circuitry 460.

The difference map generator 460 may output the generated difference map 465, and this may be input to the difference categorizer 470. Difference categorizer 470 categorizes each difference as significant or not significant. Differences categorized as significant are output from comparison circuitry 110 as potential defects.

In the example of FIG. 4, the resolution adjustment circuitry 410 is to modify the first digital image, and the registration circuitry 420 and color matching circuitry 450 is to modify the second digital image. However, any one or more of these elements may modify the other of the digital images or both digital images. Furthermore, the order of these elements may be changed, and one or more of these elements may be omitted in some arrangements.

FIG. 4 illustrates the resolution adjustment circuitry 410, registration circuitry 420 and color matching circuitry 450 as part of the comparison circuitry 110, but in some examples one or more of these elements may be provided separate from or external to the comparison circuitry 110.

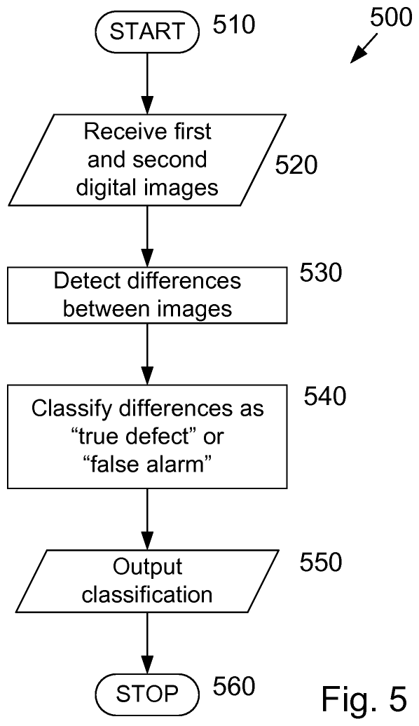

FIG. 5 shows an example of a method 500 according to some examples. The method begins at 510 and at 520 first and second digital images are received. As above, the first digital image may be a reference image and the second digital image may be the result of scanning a printed output.

Differences between the first and second digital images are detected at 530. In some examples the difference determination may be based on a SSIM index.

At 540 the detected differences are classified as a true defect or a false alarm using a neural network. The result of the classification may be output at 550. In some examples, outputting the classification generates an output to a user if the difference is classified as a true defect, but does not otherwise. In some examples, no further action is taken if the difference is classified as a false alarm. If the classification 540 classifies a difference as a true defect, the output 550 may include one or more of: displaying the second digital image to a user with annotations to indicate each difference classified as a true defect (e.g. placing bounding boxes on the image around the identified defects). In some examples, output 550 may include an instruction to automatically stop or pause a printing process. This may allow a user to review the identified defect(s) and optionally take remedial measures before the printing process is continued. In some examples, output 550 may include an instruction to automatically handle the printed output bearing the identified defect in a different manner compared with printed outputs having no identified defect. For example, an output path of the printed output may be modified to separate the printed output having the identified defect from printed outputs that have no identified defects.

The method terminates at 560.

In some examples each difference detected in 530 may be categorized as significant or not significant. The categorization may be based on a SSIM index. In examples, the classifying 540 is applied to differences determined to be significant, and is not applied to differences determined to be not significant.

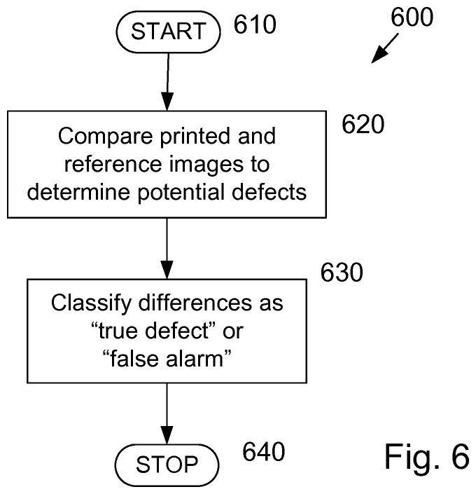

FIG. 6 shows an example of a method 600 according to some examples. The method begins at 610, and at 620 a printed image is compared with a reference image. Based on the comparison, potential defects in printed image are identified.

At 630 the differences are classified as either a “true defect” or a “false alarm” by a neural network, and the method terminates at 640.

In some examples, the neural network includes a plurality of layers connected in sequence, the plurality of layers including a convolutional layer to apply a convolutional kernel to an input to the convolutional layer. The plurality of layers may further include a pooling layer to down-sample an input to the pooling layer. The plurality of layers may also include a classification layer to classify an input to the classification layer. The convolutional layer may have fewer connections to its previous layer than the classification has to its previous layer.

The plurality of layers may include more than one of any of the convolutional layer, pooling layer and/or classification layer.

The neural network may classify each potential defect as a true defect or one of a predetermined set of false alarm classes. In some examples, the false alarm classes include one or more of Moiré, Dust, Noise, Illumination and Color Inconsistency and Misalignment.

In some examples, a defect may be indicated to a user in response to a potential defect being classified as a true defect. For example, an image of the defect may be presented to the user, or an image of the printed image with the potential defects classified as true defects being marked (e.g. by a bounding box, such as a red rectangle, around the defect).

Table 1 illustrates results obtained when an arrangement such as that shown in FIG. 1 is used to process a set of validation images with known defects and false alarms.

TABLE 1

| | | | | | Other | |
|---|---|---|---|---|---|---|
| | Real | | | Smooth | false | Pre-class |
| | defect | Moiré | Dust | areas | alarm | accuracy |
| Real defect | 1610 | 4 | 1 | 2 | 14 | 98.71% |
| Moiré | 8 | 1669 | 0 | 0 | 0 | 99.52% |
| Dust | 0 | 0 | 1462 | 0 | 0 | 100% |
| Smooth | 0 | 0 | 0 | 1412 | 0 | 100% |
| areas | | | | | | |
| Other false | 15 | 0 | 0 | 0 | 1941 | 99.23% |
| alarm | | | | | | |

Diagonal elements of the table indicate accurate classification of potential defects, whereas off-diagonal elements indicate incorrect classification. In some examples, arrangements that detect defects based on a defect map, without using a neural network to classify potential defects, have an error rate of around 0.5%. Examples of arrangements that make use of a neural network to classify potential defects may reduce the error rate to around 0.25%.

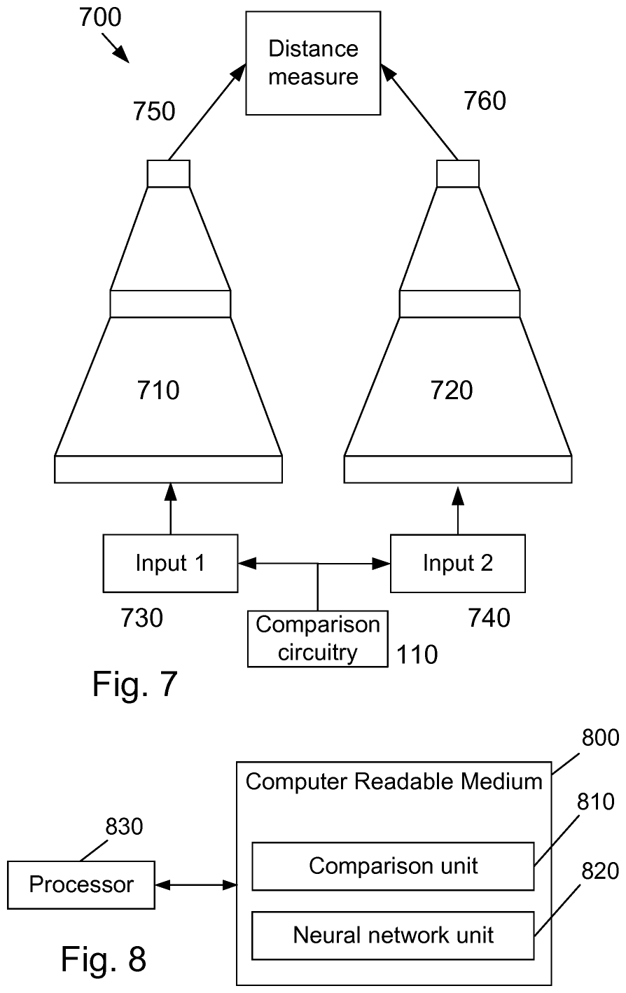

FIG. 7 illustrates an example including a Siamese neural network 700. The Siamese neural network includes a first subnetwork 710 and a second subnetwork 720. The first and second subnetworks may be identical; that is, the weights of connections in the second subnetwork may be the same as those in the first subnetwork. A first input 730 may be input to the first subnetwork 710 and a second input 740 may be input to the second subnetwork 720. The first subnetwork 710 processes the first input 730 and outputs a first feature vector 750. The second subnetwork 720 processes the second input 740 and outputs a second feature vector 760. The first 750 and second 760 feature vectors may then be compared to infer similarity, or a relationship, between the first 730 and second 740 inputs. For example, Siamese networks may be suitable for analyzing two handwriting samples to determine whether or not they were written by the same person.

According to the example of FIG. 7, the neural network 120 (of FIG. 1) is a Siamese neural network and the comparison circuitry 110 provides a potential defect to a first subnetwork 710 of the Siamese neural network as a first input 730. The comparison circuitry may also provide a corresponding portion (i.e. corresponding to the region of the potential defect) of the reference image to the second subnetwork 720 as a second input 740. The potential defect may be identified as described in relation to FIG. 4, for example.

These inputs may then be processed by the first 710 and second 720 subnetworks, respectively, to generate respective first 750 and second 760 feature vectors that respectively characterize the potential defect and the corresponding region of the reference image. A comparison between these feature vectors 750, 760 may then performed to classify the potential defect. For example the potential defect may be classified as a true defect or a false alarm. In some examples, the potential defect may be classified as a true defect or one or more of Moiré, Dust, Noise, Illumination and Color Inconsistency and Misalignment.

In some examples, a potential defect is classified as a true defect if both of two conditions are met: firstly, the difference between the first 750 and second 760 feature vectors is greater than some threshold (e.g. indicating a non-trivial difference between the first and second digital images), and secondly, that the first feature vector 750 (characterizing the potential defect) is classified by the first subnetwork as a true defect, rather than a false alarm.

In some examples, the printed output may be a 3D object printed using 3D printing (or additive manufacturing) technology. Herein, the term 3D printing is used to describe any of various techniques that produce a 3D object from a digital representation. 3D printing technologies may synthesize an object by forming successive layers of the object under computer control. 3D printing techniques include, for example, fused deposition modeling, direct ink writing (or robocasting), stereolithography, powder bed and inkjet head 3D printing, electron-beam melting, selective laser melting, selective heat sintering, selective laser sintering, direct metal laser sintering, laminated object manufacturing, directed energy deposition and electron beam freeform fabrication.

In some examples the reference is a digital description of a 3D object to be printed and the printed output is a 3D printed object.

In some examples, the reference may be a first digital description, describing the 3D object to be printed. The second digital description may be generated from the 3D printed object using a 3D scanner. The 3D scanner may be a laser triangulation 3D scanner, a structured light 3D scanner, a modulated light 3D scanner, a stereoscopic system, a photometric system, a tomographic system, etc. In some examples, the 3D scanner may be a contact 3D scanner, such as a coordinate measuring machine.

According to some examples, the first digital description and/or the second digital description may be modified prior to being compared. For example, one or both digital descriptions may be modified to match a resolution (e.g. in terms of pixels or voxels), improve a registration between the digital descriptions, and/or improve a color match between the digital description. These modifications to the first and/or second digital image may be performed in a similar manner to the 2D modification described herein.

The comparison circuitry, convolutional neural network circuitry, controller, etc. may, for example, be implemented in software, hardware, firmware or any combination of these.

Some examples make use of a CNN. However, other types of neural network may also be used. The neural network may be implemented in software, hardware, firmware or any combination of these.

In some examples, parallel processing, batch processing or vector processing capability of computer hardware and software may be used to improve efficiency of the various components, such as the comparison circuitry or the neural network.

Methods described herein may be implemented using one or more processors. Instructions for causing the one or more processors to carry out the methods may be stored on computer readable medium (such as memory, optical storage medium, RAM, ROM, ASIC, FLASH memory, etc.) The medium may be transitory (e.g. a transmission medium) or non-transitory (a storage medium).

FIG. 8 illustrates a computer readable medium 800 according to some examples. The computer readable medium 800 stores units, with each unit including instructions that, when executed, cause a processor 830 or other processing device to perform particular operations. The computer readable medium 800 includes a comparison unit 810 including instructions that, when executed, cause a processing device 830 to compare a printed image with a reference image and determine potential defects in the printed image based on the comparison. The computer readable medium 800 also includes a neural network unit 820 including instructions that, when executed, cause the processing device 830 to implement a neural network to classify each potential defect as a true defect or a false alarm. The units of the computer readable medium 800 may cause a processing device 830 to operate in accordance with any of the examples described herein.

Throughout the description and claims of this specification, the words “comprise” and “contain” and variations of them mean “including but not limited to”, and they are not intended to (and do not) exclude other components, integers or operations. Throughout the description and claims of this specification, the singular encompasses the plural unless the context demands otherwise. In particular, where the indefinite article is used, the specification is to be understood as contemplating plurality as well as singularity, unless the context demands otherwise.

Features, integers or characteristics described in conjunction with a particular aspect or example are to be understood to be applicable to any other aspect or example described herein unless incompatible therewith. All of the features disclosed in this specification (including any accompanying claims, abstract and drawings), and/or all of the elements of any method or process so disclosed, may be combined in any combination, except combinations where at least some of such features and/or operations are mutually exclusive. Implementations are not restricted to the details of any foregoing examples.

1. A monitoring device, comprising:
circuitry to compare a printed output with a reference representing a target output and to determine potential defects in the printed output based on the comparison; and
circuitry to implement a convolutional neural network to classify each potential defect as a true defect or a false alarm.

2. The monitoring device of claim 1, wherein the convolutional neural network includes:
an input layer of artificial neurons for receiving a description of each potential defect;
an output layer of artificial neurons for outputting a classification of each potential defect; and
a plurality of hidden layers of artificial neurons between the input layer and the output layer.

3. The monitoring device of claim 1, wherein
the convolutional neural network is a Siamese neural network including a first subnetwork and a second subnetwork;
the first subnetwork to process a potential defect, determined by the circuitry to compare, to produce a first output;
the second subnetwork process a portion of the reference corresponding with the potential defect to produce a second output; and
the Siamese neural network is to classify the defect based on a comparison of the first output and the second output.

4. The monitoring device of claim 1, wherein
the reference is a first digital image describing a target output image to be printed on a medium,
the printed output is a printed output image printed on the medium, and
the circuitry to compare is to receive the first digital image and a second digital image, the second digital image representing the printed output image, and determine the potential defects by comparing the first digital image and the second digital image.

5. The monitoring device of claim 4, wherein the circuitry to compare is to:
modify at least one of the first digital image and the second digital image to at least one of:
match a color space of the first digital image and a color space of the second digital image,
match a resolution of the first digital image and second digital image,
improve registration between corresponding elements of the first digital image and the second digital image, or
reduce color inconsistencies between the first digital image and second digital image, and
the circuitry to compare is to compare the first digital image and the second digital image after the modifying.

6. The monitoring device of claim 4, wherein the circuitry to compare is to determine the potential defects by applying a structural similarity, SSIM, index to differences identified by the comparison between the first digital image and the second digital image.

7. The monitoring device of claim 4, wherein the convolutional neural network is to perform a first classification to classify each potential defect as being one of a first set of classes, the first set of classes including Real Defect and one or more of Moiré, Dust, Noise, Illumination and Color Inconsistency and Misalignment, wherein:
the potential defect is classified as a true defect if the first classification classifies the difference as a Real Defect, and
the potential defect is classified as a false alarm if the first classification classifies the difference as Moiré, Dust, Noise, Illumination and Color Inconsistency or Misalignment.

8. A printing device comprising:
the monitoring device of claim 3;
an input to receive print instructions, the print instructions including the reference representing the target output;
an image fixing section to apply the printed output image to the medium;
a scanner to generate the second digital image by scanning the printed output image.

9. The printing device of claim 1, wherein the reference is a digital description of a 3D object to be printed and the printed output is a 3D printed object.

10. A method comprising:
receiving a first image and a second image, the first image and the second image being digital images;
comparing the first image with the second image to detect differences between the first image and the second image;
classifying differences detected by the comparing as a true defect or a false alarm using a neural network; and
outputting the result of the classification.

11. The method of claim 10, further wherein:
the comparing includes categorising each detected difference as significant or not significant based on a structural similarity, SSIM, measure, and
the classifying omits differences categorised as not significant.

12. Machine-readable instructions provided on at least one machine-readable medium, the instructions to cause processing circuitry to:
compare a printed image with a reference image and determine potential defects in the printed image based on the comparison; and
implement a neural network to classify each potential defect as a true defect or a false alarm.

13. The machine readable instructions of claim 12, wherein the neural network includes a plurality of layers connected in sequence, the plurality of layers including:
a convolutional layer to apply a convolutional kernel to an input to the convolutional layer,
a pooling layer to down-sample an input to the pooling layer, and
a classification layer to classify an input to the classification layer, wherein
the convolutional layer has fewer connections to its previous layer than the classification layer has to its previous layer.

14. The machine readable instructions of claim 12, wherein the neural network is to classify each potential defect as a true defect or one of a predetermined set of false alarm classes.

15. The machine readable instructions of claim 12, wherein the instructions are further to indicate a defect to a user in response to classification of a potential defect as a true defect.
